(19) United States
(12) Patent Application Publication
(10) Pub. No.: US 2007/0290632 A1
(43) Pub. Date: Dec. 20, 2007

(54) DUAL-MOTOR WHOLE BODY VIBRATION MACHINE WITH TILT MODE

(75) Inventor: Clive Graham Stevens, Taichung City (TW)

Correspondence Address: STREETS & STEELE, 13831 NORTHWEST FREEWAY, SUITE 355, HOUSTON, TX, 77040, US

(73) Assignee: PROGYM INTERNATIONAL LTD., Taichung City (TW)

(21) Appl. No.: 11/761,844

(22) Filed: Jun. 12, 2007

Related U.S. Application Data
(63) Continuation-in-part of application No. 11/424,253, filed on Jun. 15, 2006.

(51) Int. Cl. H02K 33/00; A61H 1/00; H02K 41/00

(52) U.S. Cl. 318/37; 601/51

(57) ABSTRACT

A device for imparting vibration to a body is disclosed, such as may be used for whole body vibration treatment. In one embodiment, a pair of linear motors are disposed on a base. Each linear motor has a stator portion secured to the base and a moveable portion that linearly reciprocates with respect to the stator in response to a supplied current. A current source is electrically coupled to the linear motors for supplying alternating current to the linear motors. A controller is in communication with the current source for controlling movement of the linear motors at a selected phase relationship between the linear motors. A platform is coupled to the moveable portions of both linear motors using rigid rubber supports. The platform moves with respect to the base in response to movement of the linear motors. In a level mode, the dual linear motors are operated in phase, such that the platform remains level. In a tilt mode, the linear motors operate out of phase, imparting a vibrating tilt to the platform. A moveable mount, such as a rubber mount, couples the platform to the moveable portions of each linear motor to accommodate the tilt.

### CROSS-REFERENCE TO RELATED APPLICATIONS

The present application is a Continuation-In-Part of U.S. patent application Ser. No. 11/424,253, filed on Jun. 15, 2006, which is incorporated by reference in its entirety.

### BACKGROUND OF THE INVENTION

1. Field of the Invention

The present invention relates to whole body vibration machines and to motors for use with whole body vibration machines.

2. Description of the Related Art

Whole Body Vibration (WBV) is the controlled application of vibration to the human body. The benefits of applying these controlled vibrations, within a range of amplitudes, are widely recognized by scientific and fitness authorities. WBV is beneficial to exercisers of all ages, such as by improving and restoring muscle strength to athletes and by providing arthritis relief to the elderly. WBV has also been found to improve bone density, rehabilitate knee and ankle ligaments, release beneficial hormones, improve blood circulation to extremities, and even reduce pain. In addition to its favorable results in healthy adults, WBV has also been found to be beneficial to persons suffering from any of a variety of ailments and illnesses.

While some known advantages of WBV are well established, WBV remains a relatively young and exciting field of innovation. Positive health aspects of WBV continue to be discovered and explored, and exercise equipment manufacturers are simultaneously developing an array of products designed to harness the potential of WBV. Such products include platform-based machines directed to applying vertical vibration to a user while standing, as well as attachments designed to impart vibrations to existing home gyms or other exercise equipment. Areas of continued development include the types of motor used to generate vibrations, the optimization of power consumption, the features of exercise equipment that employ WBV, and the versatility of the exercise equipment.

### SUMMARY OF THE INVENTION

A device for imparting vibration to a body is disclosed. The device may be used for whole body vibration treatment of humans. A plurality of linear motors may be used to provide controlled vibration, such as by varying the frequency, amplitude, and phase relationship between the linear motors. In one embodiment, a pair of linear motors are disposed on a base. Each linear motor is configured for reciprocating linear movement in response to a supplied current. A platform configured for supporting a person is coupled to the pair of linear motors, such that the platform moves with respect to the base in response to movement of the linear motors. A current source is electrically coupled to the linear motors for supplying alternating current to the linear motors. A controller is in communication with the current source for controlling movement of the linear motors. For example, the controller may control the rate of reciprocation (frequency) of the linear motors, as well as the phase relationship between the linear motors. According to one aspect of the invention, therefore, the phase relationship between the linear motors may be selectable to cause different types of movement at the platform.

In a “tilt” mode of operation, for example, the pair of linear motors may be operated 180 degrees out of phase, while typically at the same frequency and amplitude (vertical extension). This causes the platform on which the user is supported to tilt back and forth at the frequency of the operation of the linear motors. The angle of tilt may be slight, such as less than a few degrees from horizontal. Also, the linear motors may reciprocate at frequencies of vibration between 20 and 60 Hz, which may render the tilt undetectable to the human eye. In a “level” mode of operation, the pair of linear motors may be operated in phase, while typically at the same frequency and amplitude. Thus, the platform remains level (no tilt), while still vibrating up and down due to the harmonized reciprocating movement of the linear motors.

The choice of modes and the variability of other operational parameters of the WBV machine provide a range of available WBV treatment options to the user. In one embodiment, parameters of the device such as frequency, amplitude, and phase relationship may be manually controlled by the user, such as by using the controls of a control panel. Alternatively, the controller may be pre-programmed with a variety of user-selectable programs, each having a different combination of operational parameters, as well as the choice of level or tilt mode.

Other embodiments, aspects, and advantages of the invention will be apparent from the following description and the appended claims.

### BRIEF DESCRIPTION OF THE DRAWINGS

FIG. 1 is a perspective view of a WBV machine containing a single linear motor assembly.

FIG. 2 is an exploded view of one of the linear motor assemblies of the present invention showing an arrangement of disc magnets and steel plates.

FIG. 3A is a perspective view of the spatial relationship among the coil pairs disposed within the housing of one of the linear motor assemblies of the present invention.

FIG. 3B is a perspective view of an exemplary configuration of the interior chamber of the housing of one of the linear motor assemblies, having an alignment post and an arrangement of support springs.

FIG. 4 is a perspective view of an exemplary assembled arrangement of the disc magnets and the steel plates of one of the linear motor assemblies of the present invention.

FIG. 5 is an exemplary view of a user control console that may be used with the whole body vibration machine of the present invention.

FIG. 6 is a perspective view of an embodiment of a dual-motor WBV machine of the present invention having a selectable “tilt” mode according to the invention.

FIG. 7 is a top view of the base of the WBV machine of FIG. 6 with the dual-motor housing and platform removed to show the pair of linear motors.

FIG. 8 is a partially-exploded side-view of the linear motors as attached to the platform.

FIG. 9 is a schematic diagram of the linear motors of the present invention operated 180 degrees out of phase.

FIG. 9A is a pair of sine curves graphically illustrating the phase relationship between the linear motors of FIG. 9

FIG. 10 is a schematic diagram of the linear motors operated in phase, i.e. with a phase relationship of 0 degrees with respect to each other.

FIG. 10A is a sine curve graphically illustrating the phase relationship between the linear motors of FIG. 10.

### DETAILED DESCRIPTION OF PREFERRED EMBODIMENTS

The present invention is directed to a whole body vibration (“WBV”) machine, which includes both single-motor and multi-motor embodiments. In one embodiment, a WBV machine has two linear motor assemblies, and may be referred to as a “dual-motor” WBV machine. Each linear motor assembly includes a stator and a moveable subassembly that moves axially with respect to the stator. An alternating current is applied to each linear motor to provide reciprocating movement of the moveable subassembly at a selected frequency and amplitude, resulting in a vibration at the platform. The dual-motor WBV machine includes a pair of independently controllable linear motors with a platform disposed thereon for supporting a human body. Operational parameters, such as the frequency and amplitude of the motors and a phase relationship between the motors may be manually controlled by a user or automatically controlled according to one or more of a plurality of pre-programmed routines. The dual-motor WBV machine may be operated in a level mode, wherein the pair of linear motors are operated synchronously and in-phase, so that the platform remains level while the linear motors simultaneously vibrating up and down.

The dual-motor WBV machine may also be operated in a “tilt” mode, wherein the linear motors operate out of phase, imparting a vibrating tilt to the platform. The tilt mode is particularly desirable for user comfort. Because the upper body is generally centrally loaded onto the pelvis, operating the linear motors with a 180 degree phase difference substantially confines vibration-induced user movement to at or below the user's pelvic region. The tilt mode is particularly desirable, therefore, in that it minimizes the propagation of uncomfortable vibrations to the user's head and upper body.

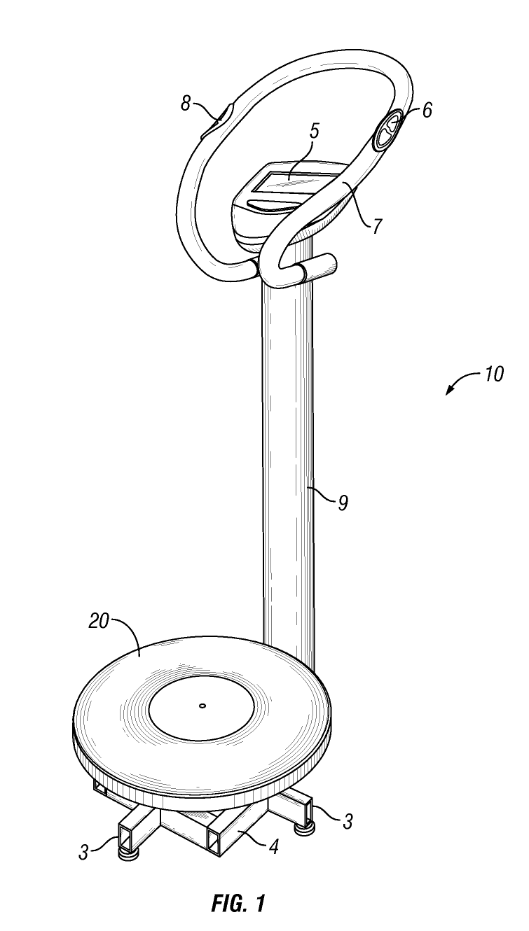

FIG. 1 is a perspective view of a single-motor whole body vibration machine (“WBV machine”) 10. The WBV machine 10 includes a single linear motor assembly disposed underneath a platform 20. The platform 20 is configured for supporting the feet of a human in the standing position, though in other embodiments a platform may be configured for supporting and imparting vibrations to a human (or even an animal) in any of a variety of other positions, such as a reclining, recumbent, or seated position. The WBV machine 10 includes a plurality of supports 3 on a frame 4, and may be positioned directly on a floor of an exercise area. It is desirable, but not required, to place the WBV machine 10 on a relatively firm surface, to provide stability and to avoid excessively damping vibrations. The WBV machine may be placed, for example, on a concrete or hard-rubber gymnasium floor, or on a carpeted or non-carpeted floor in a home exercise area. A column 9 extends from the frame 4 and supports a set of controls 6, 8 and a handrail 7. An optional user interface (alternatively referred to as a “control console”) 5 includes a display that provides the user with any of a variety of exercise-related feedback and information, such as time, vibration amplitude and frequency, duration of the WBV treatment, heart rate, and visual entertainment.

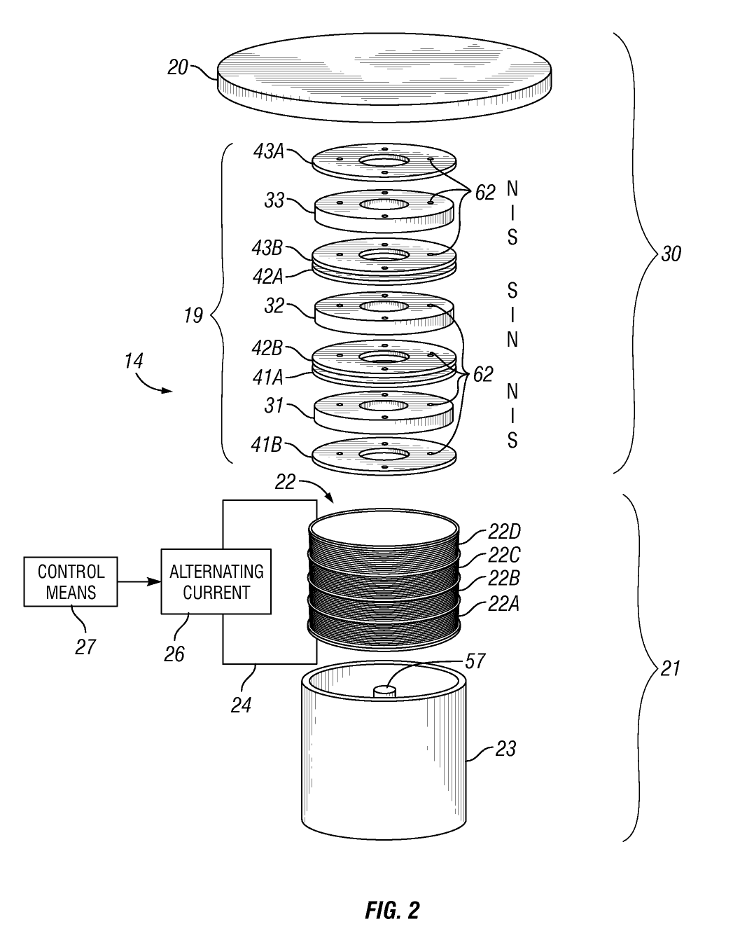

FIG. 2 is an exploded view of a linear motor assembly 14 that may be included with the WBV machine 10 of the present invention. The linear motor assembly 14 includes a stator 21 and a movable subassembly 30 that moves axially with respect to the stator 21 in response to an electromagnetic operation described below. The stator 21 includes a housing 23 and a coil assembly 22 rigidly secured to the housing 23. The housing 23 may be made of a generally magnetically conductive material, such as a low carbon metal. The moveable subassembly 30 includes a magnetic disc assembly 19 to which the platform 20 is rigidly secured. When the linear motor assembly 14 is assembled (i.e. collapsed with respect to the exploded view of FIG. 2), the disc assembly 19 is disposed concentrically within, and axially moveable with respect to, the coil assembly 22. A controller schematically shown and generally described as a “control means” 27 is used to apply an alternating electric current 26 to the coil assembly 22, as further described below. This “electrical excitation” of the coil assembly 22 causes the disc assembly 19 to oscillate at a controlled amplitude and frequency within the coil assembly 22. Thus, the linear motor assembly 14 produces a controlled, generally vertically-oriented vibration to a user standing on the platform 20.

The disc assembly 19 includes generally aligned disc magnets 31, 32, 33, each “sandwiched” between steel discs 41A and 41B, 42A and 42B, and 43A and 43B, so that the disc assembly 19 resembles a “stack of discs.” The “bottom” disc magnet 31 is disposed between steel disc pair 41A and 41B, the “middle” disc magnet 32 is disposed between steel disc pair 42A and 42B, and the “top” disc magnet 33 is disposed between steel disc pair 43A and 43B. Each steel disc pair strategically conditions and redirects the magnetic field of the disc magnet disposed intermediate the steel disc pair to enhance the electromagnetic response imparted to each disc magnet upon electrical excitation of the adjacent coil pair. The magnetic flux produced by each disc magnet 31, 32 and 33 is directed by the steel plate pairs 41A and 41B, 42A and 42B, and 43A and 43B.

As shown in FIG. 2, the disc magnets 31, 32 and 33 are arranged so that each disc magnet imparts a repelling force to the adjacent disc magnet. This is accomplished by orienting adjacent magnets such that like poles on the adjacent magnets face toward one another. For example, the bottom disc magnet 31 has a south pole “S” facing downwardly and a north pole “N” facing upwardly toward the middle disc magnet 32. The middle disc magnet 32 has a north pole “N” facing downwardly toward the north pole of the bottom disc magnet 31, and a south pole “S” facing upwardly toward the top disc magnet 33. The top disc magnet 33 has a south pole “S” facing downwardly toward the south pole of the middle disc magnet 32 and a north pole “N” facing upwardly. Orientation of the disc magnets 31, 32, 33 in this manner aggregates magnetic flux, which contributes to a greater overall electromechanical force between the stator 21 and moveable subassembly 30 when passing current through the coils of the coil assembly 22. This arrangement may provide significant magnetic cushioning of the transfer of vibrations from the moveable subassembly 30 of the linear motor assembly 14 to the platform 20 displaced by electromagnetic force applied to the disc assembly 19.

The coil assembly 22 in this configuration includes four aligned coils 22A, 22B, 22C, 22D that may be formed on an electrically non-conducting material, such as a composite polymer. For purpose of discussion, the four coils 22A-D may be grouped as a set of three pairs of counter-wound coils: a first coil pair 22A-22B, a second coil pair 22B-22C, and a third coil pair 22C-22D. Coil 22B is counter-wound relative to coil 22A, coil 22C is counter-wound relative to coil 22B, and coil 22D is counter-wound relative to coil 22C. The housing 23 supports and positions the disc magnets 31, 32, and 33 within the zone of electromagnetic influence of the fields generated upon electrical excitation of the coil assembly 22. Specifically, disc magnet 31 is positioned intermediate coil pair 22A-22B, disc magnet 32 is positioned intermediate coil pair 22B-22C, and disc magnet 33 is positioned intermediate coil pair 22C-22D.

The coil assembly 22 is thereby configured to generate, within each coil pair, a corresponding pair of cooperating magnetic fields imparted, respectively, to disc magnets 31, 32 and 33. The N-S arrangement of the magnetic poles of disc magnets 31, 32 and 33 cooperate with the above described arrangement of coil pairs 22A-22B, 22B-22C and 22C-22D, to simultaneously urge all disc magnets 31-33 in the same direction upon electrical excitation of the coil assembly 22. In response to application of current having one polarity, the disc assembly 19 moves in one linear direction with respect to the coil assembly 22. In response to current having the reverse polarity, the disc assembly 19 moves in the opposite linear direction with respect to the coil assembly 22. By alternating the current applied to the coil assembly 22, vibrations are thereby produced at the platform 20 in relation to the frequency of the alternating current.

The operation of the linear motor assembly 14 involves the delivery of current pulses to the coil pairs. As shown in FIG. 2, an alternating current source 26 intermittently applies a current to the wire that is wound to form each of the four coils 22A, 22B, 22C and 22D. The four coils form three pairs of counter-wound coils coupled one to the others, as previously described. Upon electrical excitation, each coil pair generates a pair of magnetic fields generally aligned with the faces of the disc magnets. Coil 22A generates a magnetic field having a south pole vertically aligned with and below the south pole of disc magnet 31 to repel the disc magnet upwardly, and the south pole of the generated magnetic field from coil 22B disposed vertically aligned with and above the north pole of disc magnet 31 to attract the disc magnet 31 upwardly, for a combined upward responsive force against platform 20. The north pole of the magnetic field from coil 22B is disposed vertically aligned with and below the north pole of disc magnet 32 to repel the disc magnet upwardly, and the north pole of the magnetic field from coil 22C is disposed vertically aligned with and above the south pole of disc magnet 32 to attract the disc magnet 32 upwardly, for a combined upward responsive force against platform 20. The south pole of the magnetic field from coil 22C disposed vertically aligned with below the south pole of disc magnet 33 to repel the disc magnet upwardly, and the south pole of the magnetic field from coil 22D is disposed vertically aligned with and above the north pole of disc magnet 33 to attract the disc magnet upwardly, for a combined upward responsive force against platform 20.

Typically, the power source fed to the invertor will be AC from an electrical grid. The invertor receives the AC and first converts an AC phase to DC, to produce DC with minimal “ripple”. This DC is then fed to a high side driver and a low side driver within the invertor that conditions and delivers, in harmony, the positive and negative electrical phase components, respectively, to produce a modified AC wave form fed to the linear motor assembly 14. The power to the linear motor assembly 14 is varied by control of the voltage, and the frequency of the vibrations produced by the linear motor assembly 14 is varied by control of the frequency of the conditioned AC fed to the linear motor assembly 14. The current wave form that exits the invertor is in effect a sine wave.

Some high-quality invertors may produce an almost pure sine wave AC, while other, typically less expensive invertor models may produce a quasi-square wave AC. Although the frequency and power delivered by the sine wave and the square wave are the same, the wave form is different. The performance of the linear motor assembly 14 is less dependent on the shape of the wave form than the performance of a rotary motor. With pulsed current and strategic positioning of magnets, the summation of the like poles repelling and opposing poles attracting provides an intermittent pulsed upward and downward force against the platform 20 creating vibrations of a frequency and amplitude controllable using a control means 27.

Positioning of the disc magnet relative to the coil pair is important to the efficient and effective operation of the linear motor assembly 14. The magnet and its associated upper and lower plates must be generally positioned intermediate the coil pair for maximum effectiveness since the force imparted to the disc magnet is a function of the positioning of the magnetic field of the magnet relative to the magnetic fields generated by the coils upon electrical excitation with the intermittent current. Each coil generates a magnetic field having a north pole and a south pole, and the proper positioning of the disc magnet relative to the coil is critical to the production of a response to the current in the coil.

The linear motor assembly 14 is adapted for adjusting to varying loads on the platform 20. The linear motor assembly 14 requires more power to produce the same frequency and amplitude of displacement for a heavier body on platform 20. The displacement of the platform 20 depends in part on the load on the platform 20 and also on the power applied to the linear motor assembly 14 through alternating current 26. The weight of the user standing on the platform 20 will necessarily vary among users of the WBV machine. According to one embodiment, a predetermined amount of electrical power is initially applied to the coil assembly 22 of the linear motor assembly 14 upon activation of the linear motor assembly 14 to produce a displacement of the platform 20. When the user sets the displacement amplitude using the control console 5 (FIG. 1), a predetermined current is applied to the linear motor assembly 14 to produce vibrations. A displacement amplitude sensor measures the vibration of platform 20. A feedback controller in the control means receives the measurement from the displacement sensor and adjusts the electrical current feed to the linear motor assembly 14 to achieve the desired displacement amplitude sought by the user.

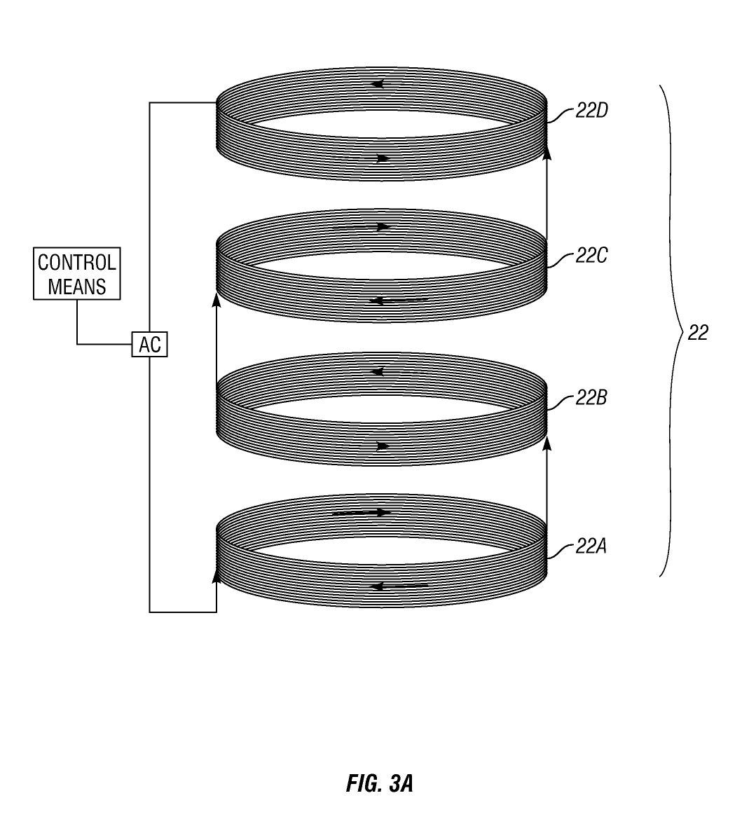

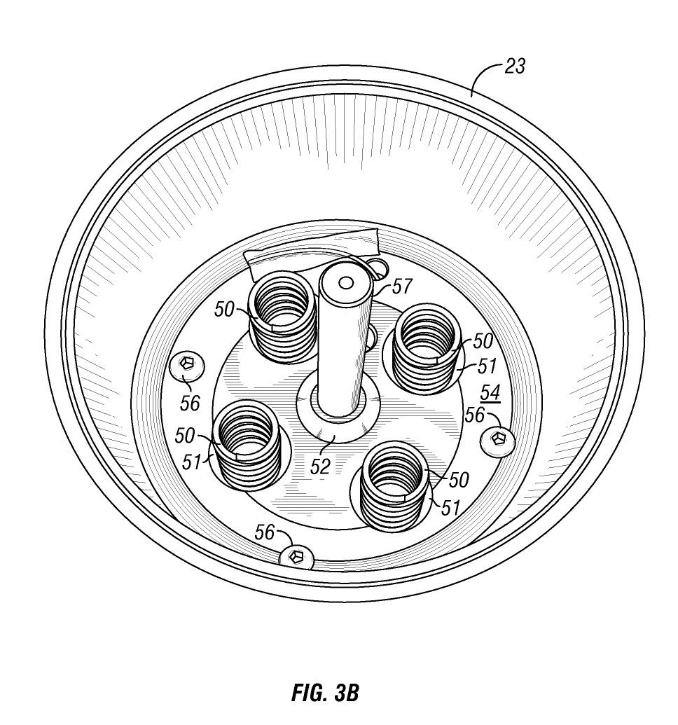

FIG. 3A is a perspective view of the coil assembly 22 and the counter-wound relationship among the coil pairs 22A-22B, 22B-22C, and 22C-22D, that are disposed within the housing 23 to generally surround the moveable subassembly of the linear motor assembly 14. The alternating current fed to the linear motor assembly 14 is supplied using what is schematically shown as the control means 27. The control means may be a any device that conditions an alternating current, such as computer, microprocessor, a current invertor, or combinations thereof. The linear motor assembly 14 may be adapted to operate on an electrical current having any voltage. In one example, the voltage may be within a range of between 12 to 400 volts. In another example, the voltage may be within a range of between 100 to 300 volts.

FIG. 3B is a perspective view of the interior chamber 54 of the housing 23 of one embodiment of the present invention. The housing 23 has an alignment post 57 generally disposed in the center of the chamber 54 and an arrangement of support springs 50 positioned within spring wells 51. The generally circumferential arrangement of support springs 50 contact and support steel disc 41B and weight bearing upon it, including but not limited to the disc magnets 31, 32 and 33, steel discs 41A, 42A, 42B, 43A and 43B, platform 20, and the user on platform 20, when the motor is not engaged. The alignment post 57 is adapted for being slidably received within the aligned apertures in disc magnets 31, 32, 33 and steel discs 41A, 41B, 42A, 42B, 43A and 43B to prevent movement of these components against the internal wall of the housing 23. Support springs 50 are adapted to accommodate movement of the moveable subassembly 30 of the linear motor assembly 14. The spring constant is designed to support the user and platform without excessively compressing, to avoid “bottoming out” when the user is supported by the platform, and may also help maintain the desired positioning of the disc magnets 31, 32, 33.

The linear motor assembly 14 will work without the use of a pure sine wave profile on the intermittent AC current because it does not rotate. A significant advantage of the linear motor assembly 14 is that it may be driven using one phase of an AC, whereas a rotary motor requires three phases to excite the stator, with each phase advancing the rotor of the motor 1200 to achieve one revolution.

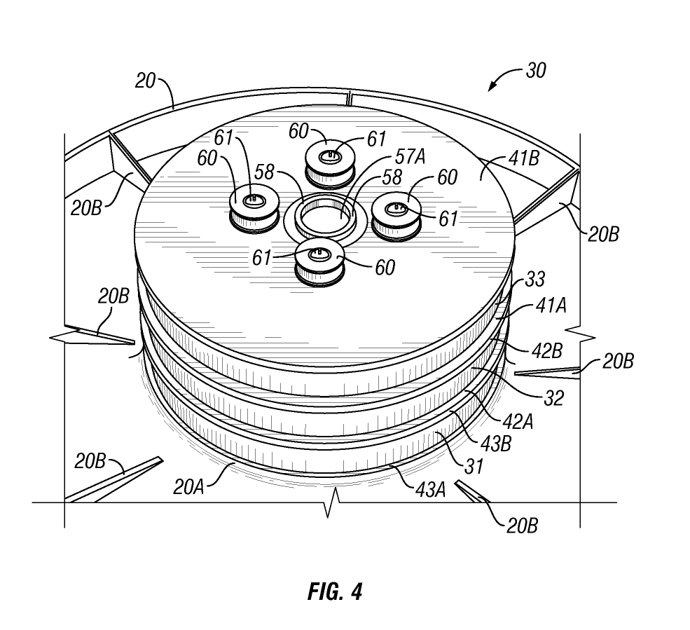

FIG. 4 is a perspective view of the moveable subassembly 30 as viewed from below, i.e. inverted from its orientation within the housing as shown in FIG. 2. FIG. 4 shows the disc magnets 31, 32, 33 and the steel discs 41A, 41B, 42A, 42B, 43A and 43B in their assembled relationship as they are disposed within the housing. The moveable subassembly is shown in FIG. 4 in a compressed condition, wherein the stack of disc magnets 31, 32, 33 and steel discs are forced into close proximity against the magnetic repulsion forces to form a compressed stack. Anti-rotation protrusions 60 are secured to the moveable subassembly 30 using bolts 61 inserted through aligned bolt holes 62. The bolts 61 receive and cooperate with nuts (not shown) on the opposite face of the moveable subassembly 30 are used to secure the moveable subassembly 30 in a “stacked” configuration, overcoming the repulsion between adjacent disc magnets to compress the stack and aggregate magnetic flux at strategic locations. The anti-rotation protrusions 60 are distributed in a pattern coinciding with the positions of the support springs 50 (FIG. 3A) and are adapted to be received within the coil of a support spring 50 to prevent rotation of disc 43B.

Steel discs on either face of each disc magnet are magnetically secured firmly to the face of the disc magnet. Specifically, steel discs 43A and 43B are magnetically secured to the opposing faces of disc magnet 33, and steel discs 42A and 42B are magnetically secured to the opposing faces of disc magnet 32, and steel discs 43A and 43B are magnetically secured to the opposing faces of disc magnet 33. A steel disc may be magnetically secured to the round protrusion 20A extending from the underside of platform 20. Depending on the strength of the disc magnet and the load from the user, there may remain clearance between adjacent steel plates due to the magnetic repulsion forces between adjacent pairs of disc magnets. Stiffening ribs 20B are generally equally angularly distributed about the underside of the platform 20 for imparting stiffness to the platform 20. The linear bearing 58 facilitates sliding movement of the moveable subassembly 30 relative to the alignment post 57 (shown in FIG. 3A) slidably receivable within the bore 57A of the linear bearing 58. A bushing or other device known in the art may be substituted for the linear bearing 58.

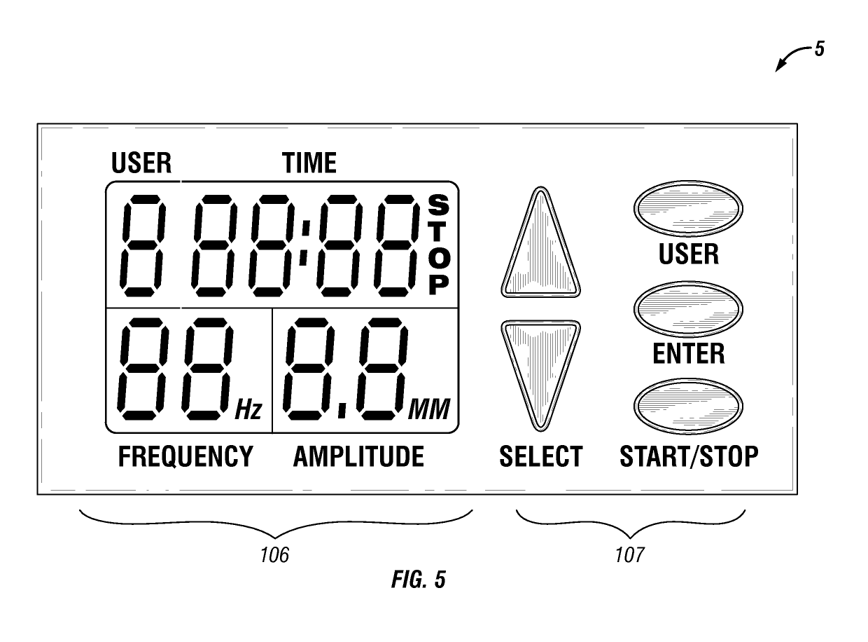

FIG. 5 is an illustration of one embodiment of the control console 5 in FIG. 1. The optional control console 5 includes a display 106 that provides the user with any of a variety of exercise-related controls and feedback, such as time, vibration amplitude and frequency, duration of the WBV treatment, heart rate. For example, the frequency of vibration of the platform 20 may be adjustable using buttons 107 on the control panel 5, for example, within the range from 20 to 60 Hz. The displacement amplitude may also be adjusted using the control panel 5, such as from 0.5 mm to 6 mm. The exercise duration may also be varied, such as for a WPB session ranging between 1 minute to 20 minutes. Shorter sessions may be accompanied by larger, more forceful vibration amplitudes. Likewise, longer sessions may entail reduced amplitudes. The relationship between time, frequency, and amplitude may be pre-programmed according to such predefined relationships. For example, a selection of different programs may be available to the user, comprising different combinations of these parameters. The control console 5 may also provide visual entertainment such as movies, simulated exercise environments, or other audio, visual, or audiovisual stimulation, to encourage participation by the user and make the WBV session more enjoyable and worthwhile.

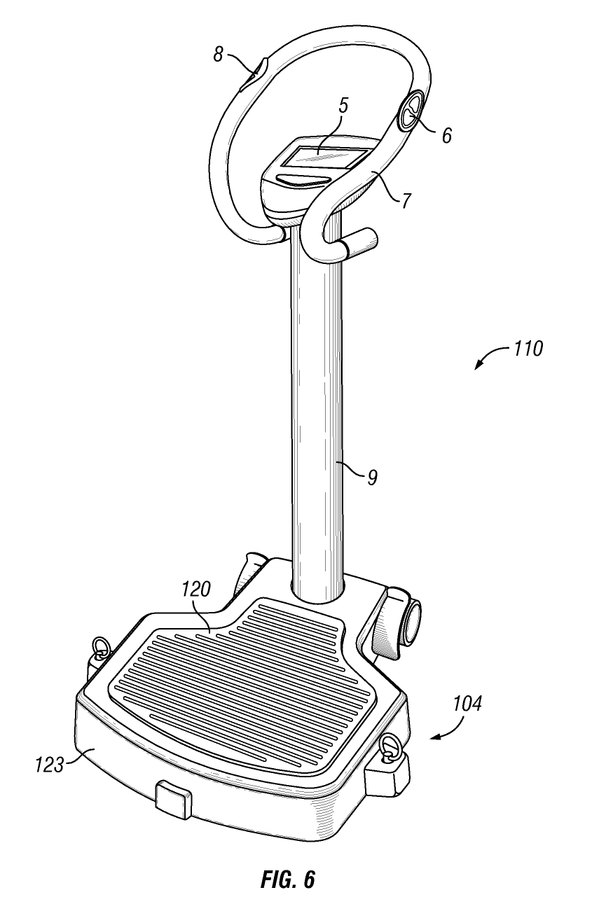

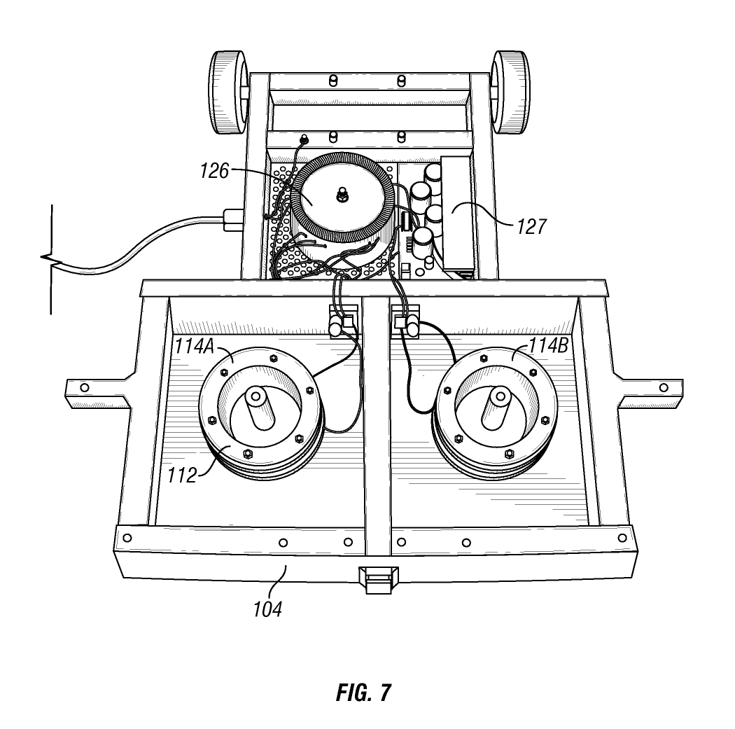

FIG. 6 is a perspective view of an embodiment of a dual-motor whole body vibration machine (“WBV machine”) 110 according to the invention. The WBV machine 110 has a dual-motor base 104 that includes a pair of independently-variable linear motors (see FIG. 7) enclosed by a housing 123. A platform 120 is supported on the pair of linear motors, and is configured for a person to stand on while receiving WBV treatment. The column 9 extends from the dual-motor base 104 and supports the handrail 7 and the user interface (“control console”) 5. The control console 5 includes a display that provides the user with any of a variety of exercise-related feedback and information, such as time, vibration amplitude and frequency, duration of the WBV treatment, heart rate, and visual entertainment. The controls 6, 8 allows a user to select operational parameters, such as duration of WBV treatment, a vibration frequency, and a vibration phase.

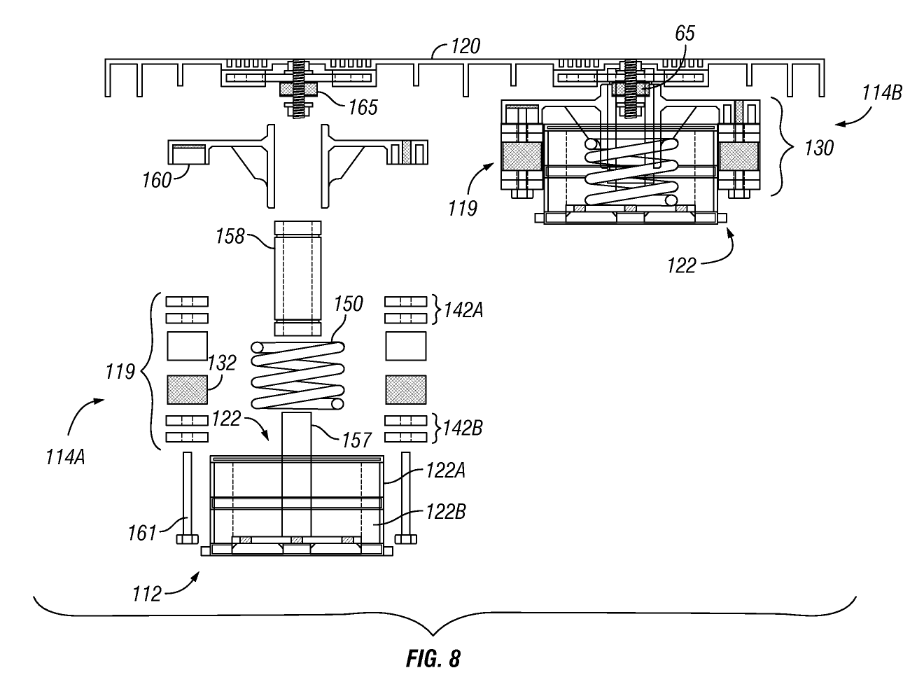

FIG. 7 is a top view of the dual-motor base 104 with the housing 123 and platform 120 removed to reveal the pair of linear motors 114A,114B secured to the base 104. Each linear motor 114A, 114B is operationally and structurally similar to the linear motor 14 in the single motor WBV machine of FIG. 2, having both an electrical coil-based stator 112 and a moveable magnetic subassembly (not shown in FIG. 7). Some structural differences between the linear motors 114A, 114B in FIG. 7 and the linear motor 14 embodied in FIG. 2 are described below in relation to FIG. 8. A current source 126 is electrically coupled to the linear motors 114A, 114B for supplying the alternating current used to operate the linear motors 114A, 114B. A controller 127 is in communication with the current source 126 for controlling the alternating current supplied by the current source 126. The controller 127 thereby independently controls the supplied alternating current to control reciprocation of the linear motors 114A, 114B. In particular, the controller 127 may independently control amplitude and frequency of the reciprocation of the two linear motors 114A, 114B, and the phase relationship between the linear motors 114A, 114B. For example, the controller 127 may control the alternating current to selectively cause the linear motors 114A, 114B to reciprocate in-phase (“0 degrees”) or diametrically out of phase (“180 degrees” apart) one relative to the other. Though the linear motors 114A, 114B are independently controllable, the two linear motors 114A, 114B are typically operated at the same frequency and amplitude, whether operated in-phase or diametrically out of phase.

FIG. 8 is a partially-exploded side-view of the linear motors 114A, 114B as attached to the platform 120. The two linear motors are assumed identical to each other in this embodiment, such that reference to a feature of one of the linear motors 114A, 114B generally applies to both. The linear motor 114A is illustrated in an exploded format and the other linear motor 114B is shown in a collapsed view (“as-assembled”). In this embodiment, a stator 112 includes a coil stack 122 having a pair of copper coils 122A, 122B electrically energized by the current source 126 (see FIG. 7). A moveable subassembly 130 of the linear motors 114A, 114B includes a magnetic ring assembly 119 comprising a magnetic ring 132 sandwiched between two sets of steel rings 142A, 142B. The coil stack 122 and magnetic ring assembly 119 are co-axial, with the coil stack 122 received within the magnetic ring assembly 119. An alignment shaft 157 receives a spring 150 and a linear bearing 158. The linear bearing 158 facilitates sliding movement of the moveable subassembly 130 relative to the alignment post 157. A flanged bearing holder 160 is supported on the linear bearing 158, and the platform 120 is supported on the bearing holder 160. The bearing holder 160 and magnetic ring assembly 119 are secured using bolts 161. Thus, the moveable subassembly 130 includes the platform 120, bearing holder 160, linear bearing 158, and magnetic ring assembly 119, all of which move together as a unit, suspended on the spring 150. When an alternating electrical current is applied to the coil stack 122, the magnetic interaction of the coil stack 122 and magnetic ring assembly 132 cause the entire moveable subassembly 130 to linearly reciprocate. This movement results in vibration at the platform 120 that may be applied to a user during WBV treatment.

When the linear motors 114A, 114B are operated diametrically out of phase, i.e. 180 degrees out of phase, an oscillating tilt is imparted to the platform 120. For example, if the linear motor 114A is moving up while the linear motor 114B is moving down, the left end of the platform 120 will move up while the right end of the platform 120 moves down, tilting the platform 120 in one direction. As the linear motors 114A, 114B reverse their respective directions, the platform 120 will tilt in the opposite direction. A tilt angle θ may vary no more than a few degrees back and forth while the linear motors 114A, 114B are operated out of phase. The tilt mode may desirably confine the transfer of vibrations to the user's pelvic region and below, thus significantly reducing the propagation of vibrations to the head and upper body region. Thus, the tilt mode typically provides greater user comfort than the level mode.

Although relative motion between the platform 120 and the linear motors 114A, 114B may be slight (e.g. less than a few degrees), the use of a rigid connection between the linear motors 114A, 114B and the base 104 could be problematic. To accommodate this relative movement, therefore, a rubber mount 165 is disposed between the platform 120 and each bearing holder 160 on which the platform 120 is supported. This provides a limited amount of relative movement between the platform 120 and the linear motors 114A, 114B—in particular, between the platform 120 and the bearing holder 160 at the location of attachment—to accommodate the relative movement between the platform 120 and the base 104. The rubber compound used in this rubber mount 165 may be extremely hard, allowing sufficient flexibility to accommodate a few degrees of tilt, while not excessively absorbing vibrations. Vibration analyzer tests have shown that the amount of vibration at the top of the linear motors is about the same as the vibration at the platform in this embodiment.

Those skilled in the art having benefit of this disclosure will recognize alternative ways to flexibly secure the platform 120 to allow limited relative movement between the platform 120 and the motors 114A, 114B. For example, a flange bearing or mechanical joint may be substituted for the rubber mounts, between the linear motors and the platform. However, over time, friction may cause the mating surfaces of a mechanical joint to wear, which could cause excessive noise and other problems if not replaced. The rubber mounts 165 in the embodiment shown provide long term reliability, as evidenced by hundreds of hours of testing without failure. The rubber mounts may reliably transfer up to 5 “g's” of force to the platform 120 up to 50 times per second.

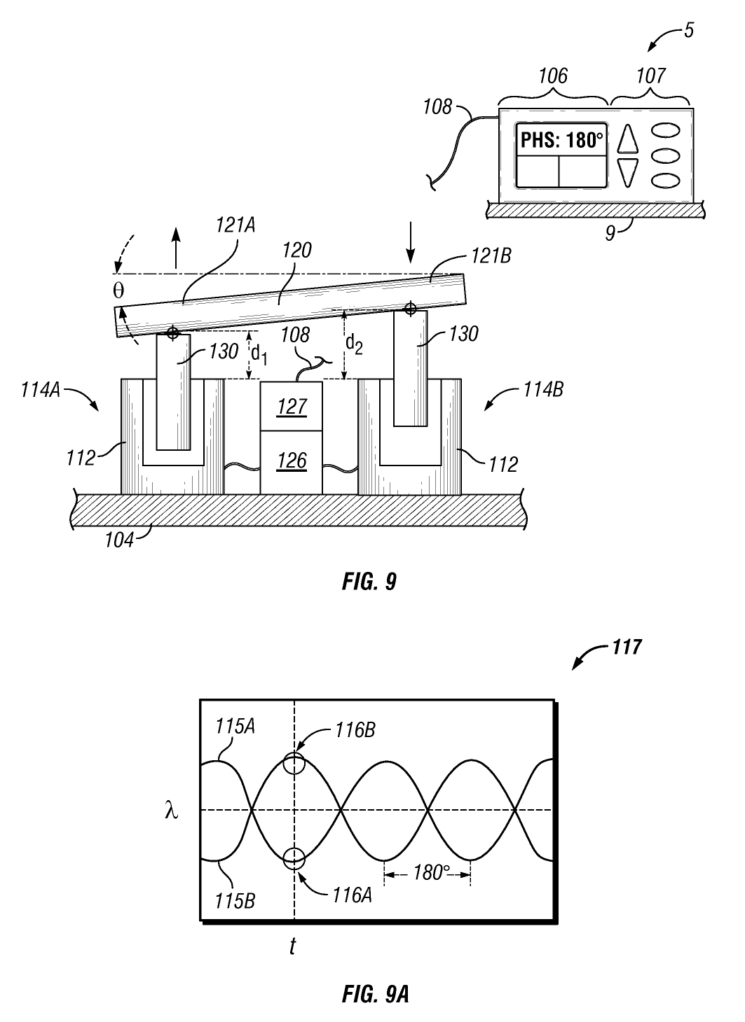

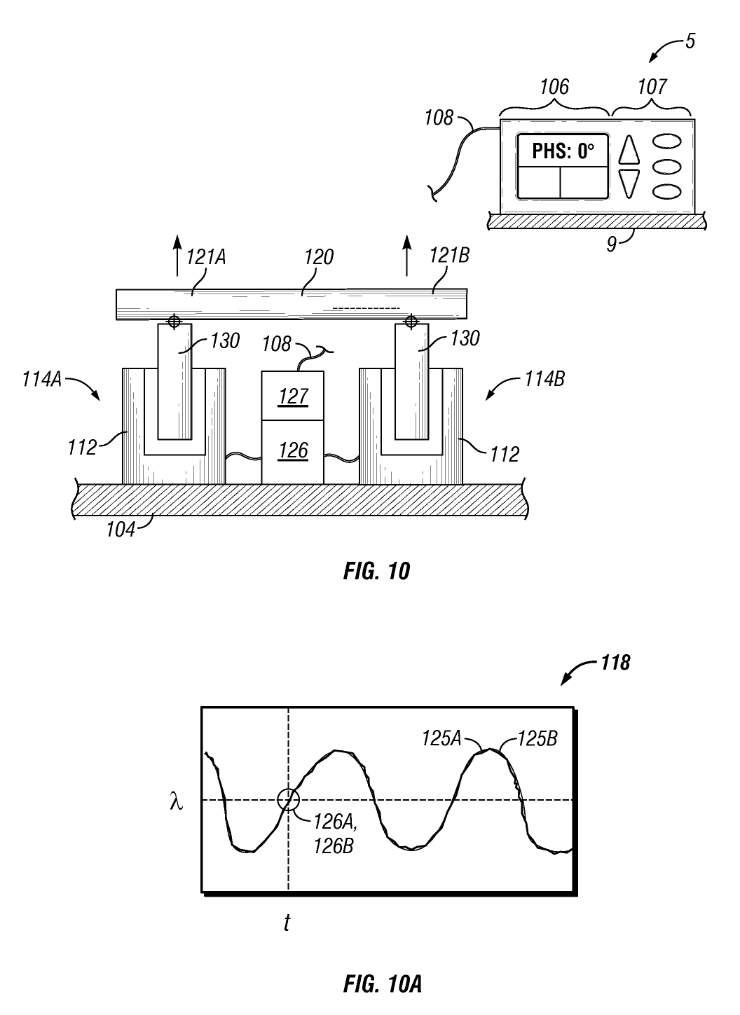

According to the invention, the linear motors may be independently controlled at selected phase relationship with respect to each other. FIGS. 9 and 10 are schematic diagrams illustrating operation of the linear motors 114A, 114B at different phase relationships. The amplitude of movement of the linear motors 114A, 114B may be slight, such as on the order of between 0 and 15 mm of linear travel. Likewise, the resulting angular tilt of the platform 120 may also be slight, such as within about 5 degrees of tilt, preferably within 3 degrees of tilt. The human eye may have difficulty seeing these displacements, particularly as the frequency increases. For example, the human eye generally cannot see the platform 120 vibrating above about 18 Hz (cycles per second). The schematic diagrams in FIGS. 9 and 10, therefore, show an exaggerated linear displacement of the linear motors 114A, 114B, and a correspondingly exaggerated angular tilt of the platform 120, to better illustrate the dynamic behavior of the dual-tilt WBV machine.

FIG. 9 is a schematic diagram of the linear motors 114A, 114B operated according to a “tilt” mode, 180 degrees out of phase. The current source 126 provides alternating current to each of the linear motors 114A, 114B to linearly reciprocate each moveably subassembly 130 with respect to the respective stator 112. The current source 126 may, for example, include two current supply modules, one of which powers the linear motor 114A and the other of which powers the linear motor 114B. The controller 127 controls the current source 126, to control the amplitude and frequency of displacement of the linear motors 114A, 114B. The controller 127 also controls the phase relationship between the linear motors 114A, 114B by independently controlling the phase of the current supplied to each of the linear motors 114A, 114B. Thus, the linear motors 114A, 114B travel in opposing directions. The device is shown at an instant wherein the linear displacement d2 of the linear motor 114B is greater than the linear displacement d1 of the linear motor 114B, imparting a tilt angle θ to the platform 120. Again, the displacements d1 and d2 and the tilt angle θ are exaggerated in the figure.

FIG. 9A is a sine chart 117 graphically illustrating the phase relationship between the linear motors 114A, 114B in FIG. 9. An idealized waveform 115A representing the periodic movement of the linear motor 114A is superimposed with an idealized waveform 115B of the linear motor 114B. The idealized waveforms 115A, 115B resemble so-called “sine functions” representative of period motion. However, as with other embodiments discussed above, it is not required that the linear motors 114A, 114B move according to a pure sine function. The amplitude λ represents the displacement of each linear motor 114A, 114B. At an instant “t,” the waveform 115A is shown at a local minimum 116A, where the linear motor 114A is on the verge of moving upward in the direction indicated. Simultaneously, the waveform 115B is shown at a local maximum 116B, where the linear motor 114B is on the verge of moving downward in the direction indicated. The distance between a local maximum of waveform 115A and an adjacent local maximum of waveform 115B is 180 degrees, which confirms the 180 degree phase relationship between the linear motors 114A, 114B.

Referring again to FIG. 9, an alternative configuration of the control console 5 in this embodiment includes an arrangement of the display 106 and buttons 107 tailored to the dual-motor functionality of the WBV machine 110. The control console 5 is in communication with the controller 127 via a signal wire 108, allowing the user to independently control the amplitude, frequency, phase relationship, and other operational parameters using the buttons 107. The display 106 in this embodiment includes a phase relationship field for displaying the phase relationship between the linear motors 114A, 114B. For example, the display 5 is shown in FIG. 9 digitally displaying a phase relationship of 180 degrees, which may be manually selected by the user or automatically selected by the controller 127. The linear motors 114A, 114B are moving in opposite directions by virtue of being 180 degrees out of phase with respect to one another. In this example, the moveably subassembly 130 of the linear motor 114A is moving upward while the moveably subassembly 130 of the linear motor 114B is moving downward.

The platform 120 is wide enough to accommodate both feet of the user. In particular, a first foot location 121A on the platform 120 is located generally above the linear motor 114A, and a second foot location 121B on the platform 120 is located generally above the linear motor 114B. While the left side of the platform 120 is moving upward, the platform 120 applies a force to the users foot at location 121A. Simultaneously, the right side of the platform 120 is moving downward, reducing the force on the user's other foot at location 121B. At a sufficiently high rate of movement/acceleration, the some separation may occur between the platform 120 and the user's foot at location 121B. However, the flexibility of the foot and the musculoskeletal connective tissues of the user's body are sufficient to absorb some of this movement so both of the user's feet remain in contact with the platform 120.

FIG. 10 is a schematic diagram of the linear motors 114A, 114B operated in a “level mode”, in phase with respect to each other. The display 106 confirms a phase relationship of 0 degrees, which may be manually selected by the user or automatically selected by the controller 127. Thus, the linear motors 114A, 114B are shown exactly in phase, each at the same linear displacement. In this example, the moveably subassemblies 130 of each linear motor 114A, 114B are shown moving upwards at the same rate, and the platform 120 is horizontal (θ=0). Because the platform 120 is level during movement, the platform 120 applies substantially the same force to each of the user's feet at locations 121A and 121B at any given moment. When the platform 120 is moving upward, as shown, a force is applied to the user's feet equally. When the platform 120 is moving downward the force applied to the user's feet decreases equally. Again, the flexibility of the user's feet and musculoskeletal connective tissues may be sufficient to absorb most of this movement to avoid any appreciable separation between the user and the platform 120.

FIG. 10A is a sine chart 118 graphically illustrating the phase relationship between the linear motors 114A, 114B in FIG. 10. An idealized waveform 125A representing the periodic movement of the linear motor 114A is superimposed with an idealized waveform 125B of the linear motor 114B. The waveform 125A is shown overlapping/coinciding with the waveform 125B at all locations, which indicates that the two linear motors 114A, 114B are synchronized and in-phase. At a time “t,” the linear motors 114A, 114B are both moving upward in the direction indicated.

While a 0-degree level mode and a 180 degree tilt mode have been disclosed, it should be recognized that dual linear motors may be controlled with phase relationships other than 0 or 180 degrees. For example, in another embodiment, the dual linear motors 114A, 114B may be operated ninety degrees out of phase from one another. In yet another embodiment, the dual linear motors 114A, 114B may be operated at a dynamically changing phase relationships, such as by varying continuously between 0 and 180 degrees during the course of a WBV session.

The amount of force applied to the user's feet increases with increasing frequency of movement of the platform 120. This level of force may be expressed in terms of its corresponding g-force “g.” (A misnomer, the term g-force is used in science and engineering as a measure of the acceleration caused by the force of gravity. The term g-force is used informally herein to mean the equivalent amount of force that would cause that acceleration.) The frequency of movement of the linear motors 114A and 114B may actually be increased to impart a force of substantially greater than 1 g to the user. Some embodiments can impose even greater than 10 g to the user. Nevertheless, even at forces greater than 1 g, the user's feet remain in contact with the platform 120 due to the flexibility of the feet and compressibility of the musculoskeletal connective tissues of the user's body.

Embodiments of a dual-motor WBV machine according to the invention provide a versatile WBV treatment. A number of operational parameters may be controlled, either manually by the user or according to pre-programming of the machine. These parameters include amplitude and frequency of movement, as well as the duration of the WBV treatment and the phase relationship between the dual linear motors. This selection may be embodied in the form of a “tilt” mode, wherein the linear motors operate at 180 degrees out of phase (e.g. FIG. 9), or a “level” mode, wherein the linear motors operate in phase (e.g. FIG. 10). These modes may be selectable, so that both modes are available on a single WBV machine.

One or more of the operational parameters may be manually selected by the user, such as using the controls of the feedback panel. Alternatively, one or more of these operational parameters may be controlled according to a variety of pre-programmed WBV routines. For example, in a manual mode of use, the user may step onto the platform 120, and, using the feedback panel, select the tilt or level mode, select the amplitude and/or frequency, and the duration of the exercise. In an automated mode of use, the user may instead select one of a plurality of pre-programmed routines (“programs”). The controller may be pre-programmed with a variety of user-selectable programs, each having a different combination of operational parameters. For example, a beginning user might select an “easy” program, having a relatively short duration, minimal amplitude and frequency, and operating in the tilt mode to minimize vibrations to the head.

Over time and repeated WBV sessions, the user's body may become more acclimated to the forces imposed by the WBV machine, so that increasingly advanced programs may be selected. More advanced programs may be characterized, for example, by increased frequency and amplitude, as well as increasing degrees of tilt. Some programs may be characterized by variable routines, wherein, for example, the mode switches intermittently between level mode and tilt mode, or between different degrees of tilt, and wherein the amplitude and frequency may also vary. A system designer may design the WBV machine according to combinations of parameters that have been pre-determined by the system designer to be safe and effective. For example, the system designer may program the controller of the WBV machine to avoid extreme combinations, such as a simultaneously maximum amplitude and maximum frequency.

Embodiments of single-motor and dual-motor WBV machines have been disclosed above. It will be recognized, however, that the invention may further include embodiments having more than two linear motors. For example, an embodiment may include three linear motors having individually controllable operational parameters such as frequency and amplitude, and having a controllable phase relationship between each of the three linear motors. In one configuration, the three motors may be positioned relative to one another such that their positions define the vertices of an equilateral triangle. The phase relationship between the first, second, and third linear motors may be controlled so that, at one particular setting, the second linear motor has a phase 90 degrees ahead of the first linear motor and the third linear motor has a phase 90 degrees ahead of the second linear motor, imposing a unique “circular” pattern of vibration on the platform. Again, the operational parameters such as amplitude, frequency, and phase relationship may be controlled at the user interface, either manually or according to pre-programmed routines.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A device for imparting vibration to a body, comprising:
a plurality of linear motors disposed on a base, each linear motor configured for reciprocating linear movement in response to a supplied current;
a platform coupled to the linear motors, such that the platform moves with respect to the base in response to movement of the linear motors;
a current source electrically coupled to the linear motors for supplying alternating current to the linear motors; and
a controller in communication with the current source for controlling movement of the linear motors at a selected phase relationship between the linear motors.

2. The device of claim 1, wherein the controller is configured for selectively controlling movement of two of the linear motors at substantially 180 degrees out of phase with respect to each other.

3. The device of claim 1, wherein the controller is configured for selectively controlling movement of the linear motors substantially in phase.

4. The device of claim 1, wherein the controller is configured for selectively varying the phase relationship between the linear motors.

5. The device of claim 1, wherein the controller is configured for controlling one or both of the amplitude and frequency of movement of the linear actuators.

6. The device of claim 5, wherein the controller is configured for selectively varying the amplitude between about 0.5 and 6 mm.

7. The device of claim 5, wherein the controller is configured for selectively varying the frequency between about 20 Hz and 60 Hz.

8. The device of claim 1, further comprising a user interface in communication with the controller, configured for user-selection of one or more operational parameters of the linear motors.

9. The device of claim 8, wherein the one or more user-selectable operational parameters include a frequency, an amplitude, and the phase relationship.

10. The device of claim 1, wherein the platform comprises a unitary structure, such that out of phase movement of the linear motors produces an oscillating tilt of the platform.

11. The device of claim 1, further comprising a moveable mount coupling each linear motor to the platform.

12. The device of claim 11, wherein the moveable mount comprises a rubber mount, a flange bearing, or a mechanical joint.
